(19) United States
(12) Patent Application Publication
(10) Pub. No.: US 2002/0136433 A1
(43) Pub. Date: Sep. 26, 2002

(54) Adaptive facial recognition system and method

(75) Inventor: Yun-Ting Lin, Ossining, NY (US)

Correspondence Address: Jack E. Haken, Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/817,108

(22) Filed: Mar. 26, 2001

(51) Int. Cl. G06K 9/00

(52) U.S. Cl. 382/118

(57) ABSTRACT

An adaptive face recognition system and method. The system includes a database configured to store a plurality of face classes; an image capturing system for capturing images; a detection system, wherein the detection system detects face images by comparing captured images with a generic face image; a search engine for determining if a detected face image belongs to one of a plurality of known face class; and a system for generating a new face class for the detected face image if the search engine determines that the detected face image does not belong to one of the known face classes. In the event that the search engine determines that the detected face image belongs to one of the known face classes, an adaptive training system adds the detected face to the associated face class.

### BACKGROUND OF THE INVENTION

1. Technical Field

The present invention relates to facial recognition, and more particularly relates to an adaptive system for detection and tracking of faces.

2. Related Art

As electronic commerce and information becomes more prevalent in our society, security issues have become an ongoing and important challenge. Such challenges exist both in peoples' business and in home environments. For instance, in business environments, security is required for transactions such as banking at an ATM, purchasing goods with a credit card, or downloading secure data from the Internet. Similarly, in some households it may be desirable to prevent children from viewing undesirable material on the internet or TV. In order to provide security in such environments, the particular systems need to correctly establish the identity of the participants. A traditional method of establishing identity is through the use of passwords, such as a PIN number. Unfortunately, because passwords can be forgotten, stolen, disseminated, etc., they provide only a limited form of security and can be readily defeated.

In order to overcome such limitations, recent security developments have focused on “biometrics,” which is a term that describes automated methods of establishing a person's identity from their unique physiological or behavioral characteristics. Fingerprinting, retina scans and handwriting recognition are all examples of biometrics that can or have been used to establish identity. Unfortunately, most security systems that use biometric applications not only require specialized hardware (e.g., a retinal scanner), but may also be seen as intrusive to one's personal privacy.

One form of biometric security that is relatively non-intrusive involves facial recognition, in which an image of a person's face can be digitally compared to a previously stored image. An example of such a system is disclosed in U.S. Reissue Pat. No. 36,041, entitled, “FACE RECOGNITION SYSTEM,” issued to Turk et al., and is hereby incorporated by reference. As disclosed, a stored reference face, which comprises facial images characterized as a set of eigenvectors or “eigenfaces,” can be used to identify or authenticate an individual.

One of the challenges of the above-mentioned face recognition system is the need to perform “off-line” training, which involves gathering multiple face images each time a new individual is added to the database of faces. Unfortunately, such a process is often too complicated, time-consuming, costly or impractical. For instance, in a relatively limited-scale environment, such as home or small office, people may lack the technical know-how or desire to set up and implement a training system. In a large-scale environment, such as a bank, it may be impractical to bring in each customer for video imaging so that they can be recognized for future ATM visits. Accordingly, a need exists for a face recognition system in which offline training is not required.

### SUMMARY OF THE INVENTION

The present invention addresses the above-mentioned problems by providing an adaptive face recognition system and method that does not require off-line training. In a first aspect, the invention provides an adaptive face recognition system, comprising: a database configured to store a plurality of face classes; an image capturing system for capturing images; a detection system, wherein the detection system detects face images by comparing captured images with a generic face image; a search engine for determining if a detected face image belongs to one of a plurality of known face class; and a system for generating a new face class for the detected face image if the search engine determines that the detected face image does not belong to one of the known face classes.

In a second aspect, the invention provides a method for performing adaptive face recognition, comprising the steps of: capturing a stream of image data; identifying a face image from the stream of image data by comparing the image data to a generic face image; searching a database of face classes to determine if the detected face image belongs to one of a plurality of known face classes; if the detected face image belongs to one of the known face classes, adding the detected face image to the face class that owns the face image; and if the face image does not belong to one of the known face classes, creating a new face class with the face image.

In a third aspect, the invention provides a program product stored on a recordable medium for performing adaptive face recognition, that when executed, comprises: a system for receiving image data; a system for detecting a face image from the received images by comparing the image data to a generic face image; a system for searching a database of face classes to determine if a detected face image belongs to one of a plurality of known face classes; a system for adding the detected face image to an associated face class if the detected face image belongs to one of the known face classes; and a system for creating a new face class with the detected face image if the detected face image does not belong to one of the known face classes.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a block diagram of an adaptive face recognition system in accordance with a preferred embodiment of the present invention.

FIG. 2 depicts an exemplary database record for the system of FIG. 1.

### DETAILED DESCRIPTION OF THE INVENTION

### Overview

The present invention provides a system that gradually learns different faces from ongoing “image collection events.” An image collection event may occur anytime an individual's face is presented and detected by the system. Rather than pre-train the system with new faces off-line, the system generates a new face class each time a new face is presented, and associates the individual's face images presented at later times to the same class. The system can be used for any application in which identity of an individual is required. Examples include, but are not limited to, intruder detection, enter-exit event detection, user profiling, human-machine interaction applications, ATM's, smart card access, etc. The system automatically updates user face feature representations on-line so that the system gradually learns appearance changes of an individual over time in a cost effective manner.

The system implements what is referred to herein as an “adaptive eigenface,” which gradually learns the specific traits of an individual's face as new images are presented to the system. In a live scene, once a face is detected, a face tracking system may be utilized to not only continuously follow the same face, but also automatically add acceptable face images of the person for on-line adaptive training. If the face is unrecognized, a new class for this person can be created. If a face image is recognized as belonging to a known class, acceptable face images can be sequentially added for adaptive training to further strengthen its class representation.

Face detection (which occurs prior to face recognition) is accomplished by comparing an obtained image with a generic face. The generic face may be created off-line ahead of time using a large number of face images from various people and is represented by a set of eigentemplates.

### Preferred Embodiment

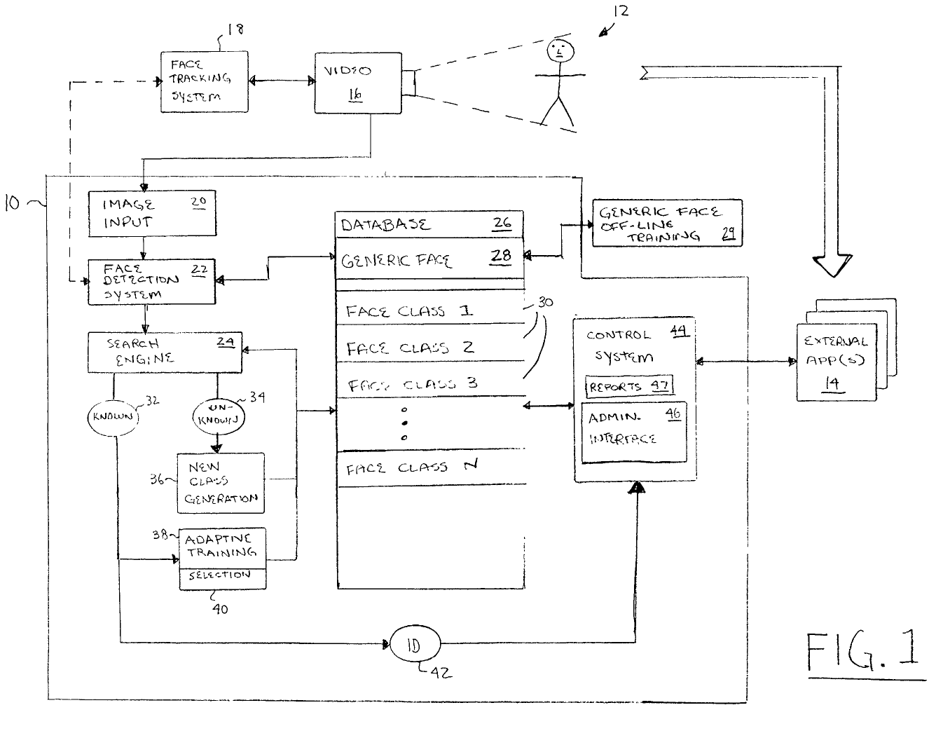

Referring now to the figures, FIG. 1 depicts an adaptive face recognition system 10, which adaptively learns and recognizes faces, such as that of individual 12. The system 10 operates by first collecting image data with a video camera 16 or similar device. Image data may comprise any type of image information, including streaming video, digital pictures, digital video, analog video, etc. Once captured, image data is then loaded into system 10 via image input 20. Image data is then passed to face detection system 22, which determines if a face image exists in the inputted image data. Faces are detected by comparing information in an inputted image with a generic face 28 stored in a database 26. Generic face 28 may be represented by a set of eigentemplates trained off-line by generic face off-line training system 29. The processes for creating a generic face are readily known in the art.

When a face image is detected by face detection system 22, search engine 24 searches the known face classes 30 of database 26 to determine if the face image belongs to one of the known classes (i.e., the face is recognized). The search engine 24 may utilize a distance criterion such as that used by an eigenface method to determine if a detected face image belongs to a known class. Such eigenface methods, which are well known in the art, represent each face class by a subspace that is spanned by a small number of principal components extracted from a set of face data containing face images of the same class. The eigenface method employs a distance criterion that considers the distance to the face subspace and the distance within the face subspace for determining if a candidate vector belongs to the same face class or not.

If it is determined that the face image belongs to one of the known classes (i.e., an owning class), it is characterized as known 32. If the face image is known 32, adaptive training system 38 may be used to sequentially update the owning class with the detected image. A selection mechanism 40 may be incorporated to select only acceptable images for training. Such on-line training may be achieved by applying a sequential eigen decomposition. Known methods for accomplishing this include the power method and/or orthogonal iterations that update the eigentemplates when new data vector information is presented to the system. As more and more faces for the same person are added, the class representation is improved, thereby improving the detection rate of the known class. Using this process, only a relatively small number of iterations will be required to either (1) adapt the generic face eigentemplates to those for a specific face, or (2) generate a new face representation from scratch.

If the search engine 24 determines that a detected face image does not belong to one of the known classes 30 (i.e., it is unknown 34), then a new class for the unrecognized face image is generated by new class generation system 36. The new class with the detected image is added to database 26. The newly created class therefore becomes one of the known classes for future searches by search engine 24. Thus, the process of off-line training is eliminated in favor of on-line sequential training. To enhance the training process, a face tracking system 18 can be utilized to control the video recorder 16 to lock onto and follow an individual's face. Thus, a tracking event can occur in which numerous different facial images of an individual can be collected during a single event. Overall, the computational costs for sequential updating is far less than initial off-line training, which generally takes a large number of data vectors to build a sufficient class representation.

In addition to detecting and adaptively training facial recognition, system 10 provides a control system 44 for controlling access to, and use of, external applications 14 based on privileges set in database 26. For instance, if a known individual 12 was seeking access to a web browser application, the control system 44 could determine the privileges allocated to individual 12 for the web browser. Specifically, when search engine 24 recognizes an individual as belonging to a known class, an identifier 42 for that person can be communicated to control system 44, which will check the associated face class for the recognized individual 12 to determine the individual's privilege level for the application 14.

Control system 44 further includes an administrative interface 46 that allows an administrator to, among other things, preset privilege levels for each application. Additionally, administrative interface 46 provides access to reports 47 generated by control system 44 that show what applications were used, when they were used, and which identified person used which application. Thus, for example, a parent could determine when a child was surfing the web, watching television, etc.

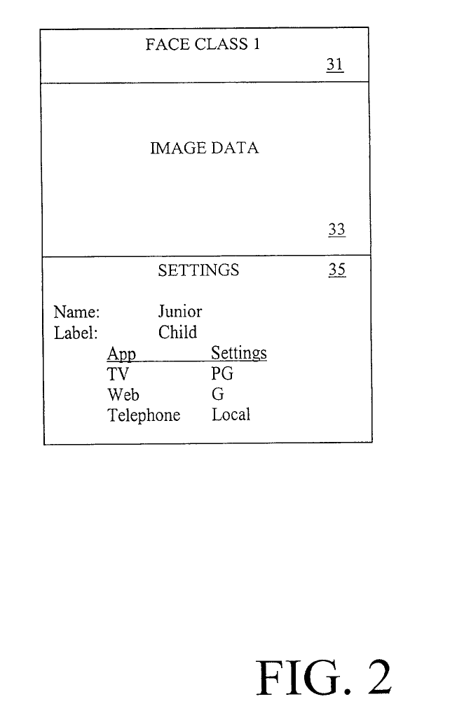

Referring now to FIG. 2, an exemplary database record 31 for face class 1 is shown. Record 31 includes image data 33 collected during a tracking event. The image data 33 may comprise, for example, eigentemplates that include frontal views, side views, etc. It should be understood that any system for storing feature representations or signatures could be utilized. Also included in record 31 are exemplary application privilege settings 35 for face class 1. In this case, the settings include a name “Junior” for the face class and a label “Child.” The label can be used to classify groups of similar individuals represented in known face classes. Other labels could include, for example, adult, employee, administrator, owner, etc. Each label could have a set of default privilege settings. In this example, the label “Child,” has several default settings that dictate the privileges for the individuals having this label. Specifically, for the three applications “TV,” “web,” and “telephone,” the Child label dictates that Junior has privilege settings of “PG,” “G,” and “local.” Labels and associated default settings may be set via the administrative interface 46 by an administrator (e.g., a parent).

Accordingly, when Junior attempts to use of the three listed applications, his face image will be detected and recognized as belonging to known class 1. Control system 44 can communicate Junior's privilege settings for the application Junior seeks to use. The application can then be configured to limit Junior's use to the prescribed settings. It should be understood that the described method of implementing control system 44 and the associated settings in the known face classes is for exemplary purposes only and should not be considered limiting.

It is understood that the systems, functions, mechanisms, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

I claim:

1. An adaptive face recognition system, comprising:
a database configured to store a plurality of face classes;
an image capturing system for capturing images;
a detection system, wherein the detection system detects face images by comparing captured images with a generic face image;
a search engine for determining if a detected face image belongs to one of a plurality of known face classes; and
a system for generating a new face class for the detected face image if the search engine determines that the detected face image does not belong to one of the known face classes.

2. The adaptive face recognition system of claim 1, further comprising an adaptive training system that adds the detected face to an associated face class when the search engine determines that the detected image belongs to one of the known face classes.

3. The adaptive face recognition system of claim 2, wherein the adaptive training system adds the detected face using a sequential eigen decomposition.

4. The adaptive face recognition system of claim 1, wherein the image capturing system comprises:
a video camera; and
a face tracking system that causes the video camera to following a face.

5. The adaptive face recognition system of claim 1, wherein the generic face image is represented by a set of eigentemplates.

6. The adaptive face recognition system of claim 1, wherein the detection system utilizes a distance criterion to determine if the detected face belongs to one of the known face classes.

7. The adaptive face recognition system of claim 1, further comprising a control system for controlling access to user applications.

8. The adaptive face recognition system of claim 7, wherein the control system controls access based on an identification of one of the face classes by the search engine.

9. The adaptive face recognition system of claim 7, wherein the control system includes an administrative interface for labeling face classes and providing access to reports regarding usage of user applications.

10. A method for performing adaptive face recognition, comprising the steps of:
capturing a stream of image data;
identifying a face image from the stream of image data by comparing the image data to a generic face image;
searching a database of face classes to determine if the detected face image belongs to one of a plurality of known face classes;
if the detected face image belongs to one of the known face classes, adding the detected face image to the face class that owns the face image; and
if the face image does not belong to one of the known face classes, creating a new face class with the face image.

11. The method of claim 10, comprising the further steps of:
tracking the detected face image;
capturing additional views of the detected face image; and
adding additional views of the detected face image to the face class that owns the detected face image.

12. The method of claim 10, wherein the step of searching the database of face classes includes the step of using a distance criterion to determine if the detected face image belongs one of the known face classes.

13. The method of claim 10, comprising the further step of controlling access to an application based on the face class of the detected face image.

14. A program product stored on a recordable medium for performing adaptive face recognition, that when executed, comprises:
a system for receiving image data;
a system for detecting a face image from the received images by comparing the image data to a generic face image;
a system for searching a database of face classes to determine if a detected face image belongs to one of a plurality of known face classes;
a system for adding the detected face image to an associated face class if the detected face image belongs to one of the known face classes; and
a system for creating a new face class with the detected face image if the detected face image does not belong to one of the known face classes.

15. The program product of claim 14, wherein the system for adding the detected face image adds the detected face using a sequential eigen decomposition.

16. The program product of claim 14, further comprising a face tracking system that causes a video camera to track the detected face.

17. The program product of claim 14, wherein the system for adding the detected face image further comprising a selection system that selects only acceptable face images for adding to the associated face class.

18. The program product of claim 14, wherein the detection system utilizes a distance criterion to determine if the detected face belongs to one of the known face classes.

19. The program product of claim 14, further comprising a control system for controlling access to user applications.

20. The program product of claim 19, wherein the control system controls access based on an identification of one of the face classes by the search engine.
